(19) United States
(12) Patent Application Publication
(10) Pub. No.: US 2011/0125649 A1
(43) Pub. Date: May 26, 2011

(54) COMPUTER SYSTEM FOR MANAGING CONTENT AND CONTENT MANAGEMENT METHOD

(76) Inventors: Kazuya KUKITA, Yokohama (JP); Yoshinao Kiuchi, Kawasaki (JP); Tetsuya Oohashi, Funabashi (JP); Yusuke Obi, Kawasaki (JP)

(21) Appl. No.: 12/844,958

(22) Filed: Jul. 28, 2010

(30) Foreign Application Priority Data
Nov. 25, 2009 (JP) 2009-267212

(51) Int. Cl. G06F 21/00; G06Q 50/00

(52) U.S. Cl. 705/51; 705/310

(57) ABSTRACT

It is an object of this invention to protect a copyright for each of subcontents of a digital content. A computer system, comprising: a content providing server for providing a user terminal with a digital content obtained through digitization; and a copyright management server for managing copyright information on the digital content, wherein the content providing server is configured to: obtain copyright information set for each of subcontents included in the digital content from the copyright management server; associate the obtained copyright information with the each of the subcontents, and add the copyright information to the digital content; and transmit the digital content to which the copyright information is added to the user terminal.

### CLAIM OF PRIORITY

The present application claims priority from Japanese patent application JP 2009-267212 filed on Nov. 25, 2009, the content of which is hereby incorporated by reference into this application.

### BACKGROUND OF THE INVENTION

This invention relates to a system for managing copyright information on digital contents, and more particularly, to a technology of managing copyright information for each of subcontents contained in one file.

In recent years, as typified by electronic books, various media have been converted into electronic data. A copyright is reserved for a book, and, when the book is converted into data, by adding copyright information on the book to a file of an electronic book, the copyright of the book is protected as disclosed in, for example, Japanese Patent Application Laid-open No. Hei 8-190545.

In many cases, a book such as a novel has one copyright holder. However, a magazine may have different copyright holders for each of subcontents (such as documents, images, or music compositions) contained in the magazine. When such a magazine is converted into data, the copyright of the magazine converted into data is managed on a file basis, and thus management of copyright for each of subcontents contained in the magazine is not taken care of.

Moreover, when information on all copyrights reserved for the magazine is contained in the copyright information added to the file, a subcontent contained in the magazine and the copyright information are not associated with each other, and thus the subcontent cannot be separated from the magazine. Further, when the magazine is divided into the subcontents, copyright information is not added to the divided subcontents, and the copyrights of the subcontents are not possibly protected properly.

### SUMMARY OF THE INVENTION

It is an object of this invention to protect a copyright for each of subcontents of a digital content.

According to one embodiment of the invention, there is therefore provided a computer system, comprising: a content providing server for providing a user terminal with a digital content obtained through digitization; and a copyright management server for managing copyright information on the digital content, wherein the content providing server is configured to: obtain copyright information set for each of subcontents included in the digital content from the copyright management server; associate the obtained copyright information with the each of the subcontents, and add the copyright information to the digital content; and transmit the digital content to which the copyright information is added to the user terminal.

According to the representative aspect of this invention, a copyright of a digital content can be protected for each of subcontents, and, when the digital content is edited, a copyright of each of the subcontents can be inherited.

### BRIEF DESCRIPTION OF THE DRAWINGS

The present invention can be appreciated by the description which follows in conjunction with the following figures, wherein:

FIG. 1 is a block diagram illustrating a configuration of a computer system according to the embodiment of this invention;

FIG. 2 is a block diagram illustrating a configuration of the digital content management server according to the embodiment of this invention;

FIG. 3 is a diagram illustrating a configuration of the digital content database according to the embodiment of this invention;

FIG. 4 is a diagram illustrating a configuration of the copyright information database according to the embodiment of this invention;

FIG. 5 is a diagram illustrating a configuration of the content information database of the embodiment according to this invention;

FIG. 6 is a diagram illustrating a configuration of the license information database of the embodiment according to this invention;

FIG. 7 is a diagram illustrating an overview of processing of creating a file of a digital content according to the embodiment of this invention;

FIG. 8 is sequence diagram of processing of newly registering a digital content by the terminal for digital content registration according to the embodiment of this invention;

FIG. 9A is a sequence diagram of processing of acquiring a digital content by the end-user terminal according to the embodiment of this invention;

FIG. 9B is a sequence diagram of processing of browsing a digital content by the end-user terminal according to the embodiment of this invention;

FIG. 10 is a flowchart of processing of browsing a digital content according to the embodiment of this invention; and

FIG. 11 is a flowchart of processing of printing a digital content according to the embodiment of this invention.

### DETAILED DESCRIPTION OF THE PREFERRED EMBODIMENT

An embodiment of this invention is detailed below referring to accompanying drawings.

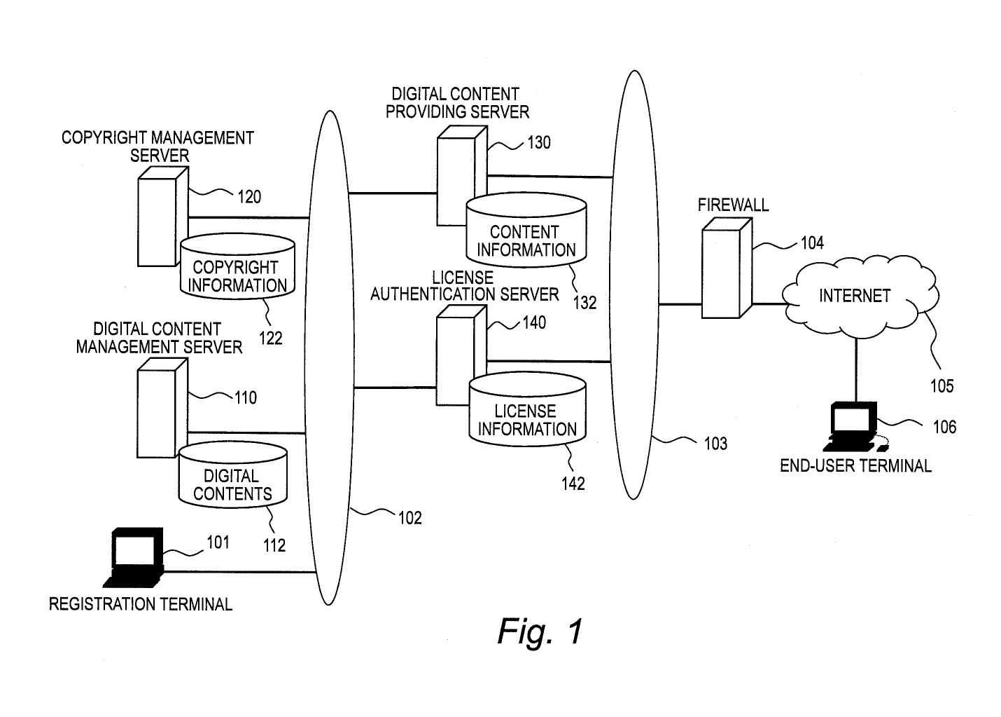

FIG. 1 is a block diagram illustrating a configuration of a computer system according to the embodiment of this invention.

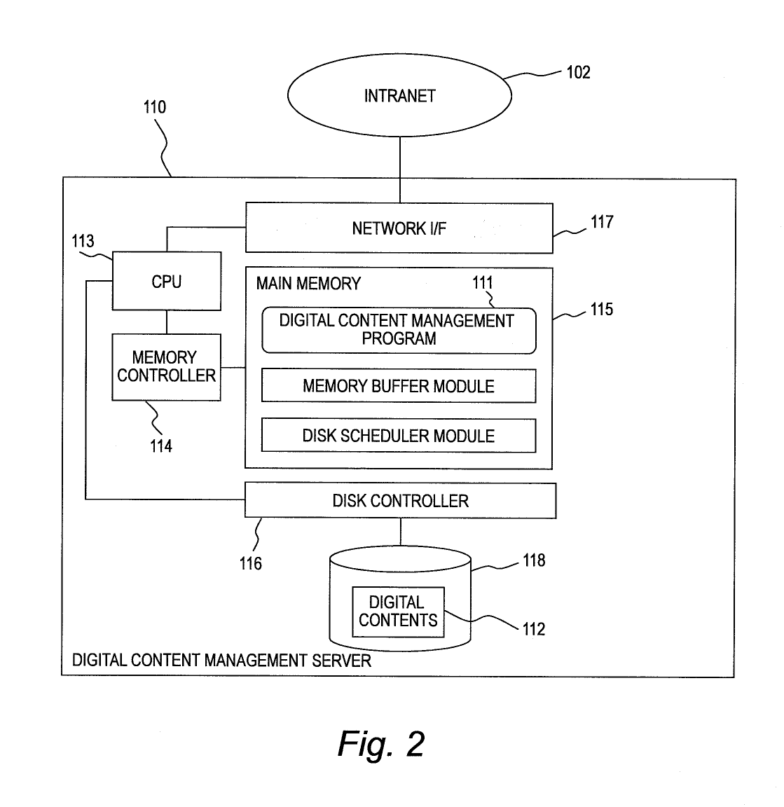

The computer system according to this embodiment includes a digital content management server 110, a copyright management server 120, a digital content providing server 130, and a license authentication server 140. Each of the servers is a computer including a processor, a memory, and an interface (refer to FIG. 2), and is coupled to an intranet 102 via the interface. The digital content providing server 130 and the license authentication server 140 are also coupled to a global network 103, are then coupled via a firewall 104 to the Internet 105, and are thus accessible via the Internet 105 from an end-user terminal 106.

A registration terminal 101 is a computer including a processor, a memory, and an interface. The registration terminal 101 transmits, to the digital content management server 110, request for newly registering a digital content, a request for browsing the digital content, and a request for editing the digital content. Moreover, the registration terminal 101 transmits, to the copyright management server 120, a request for newly registering copyright information, a request for browsing the copyright information, and a request for editing the copyright information.

The end-user terminal 106 is a computer including a processor, a memory, and an interface. The end-user terminal 106 makes a request for digital content acquisition to the digital content providing server 130. Moreover, the end-user terminal 106, when an acquired digital content is to be browsed, requests for authentication by the license authentication server 140.

Though, in FIG. 1, only the single registration terminal 101 and the single end-user terminal 106 are illustrated, a plurality of the terminals for digital content registration 101 and a plurality of the end-user terminals 106 may be provided.

FIG. 2 is a block diagram illustrating a configuration of the digital content management server 110 according to the embodiment of this invention.

In FIG. 2, the digital content management server 110 includes a processor (CPU) 113, a memory controller 114, a main memory 115, a disk controller 116, a network I/F 117, and a storage device 118.

The processor 113 carries out various processing by executing programs stored in the main memory 115, thereby controlling the main controller 114, the disk controller 116, and the network I/F 117. The memory controller 114 controls an access to the main memory 115 according to an instruction received from the processor 113. The main memory 115 stores the programs to be executed by the processor 113 (such as a digital content management program 111) and data required for the execution of the programs (such as digital content data).

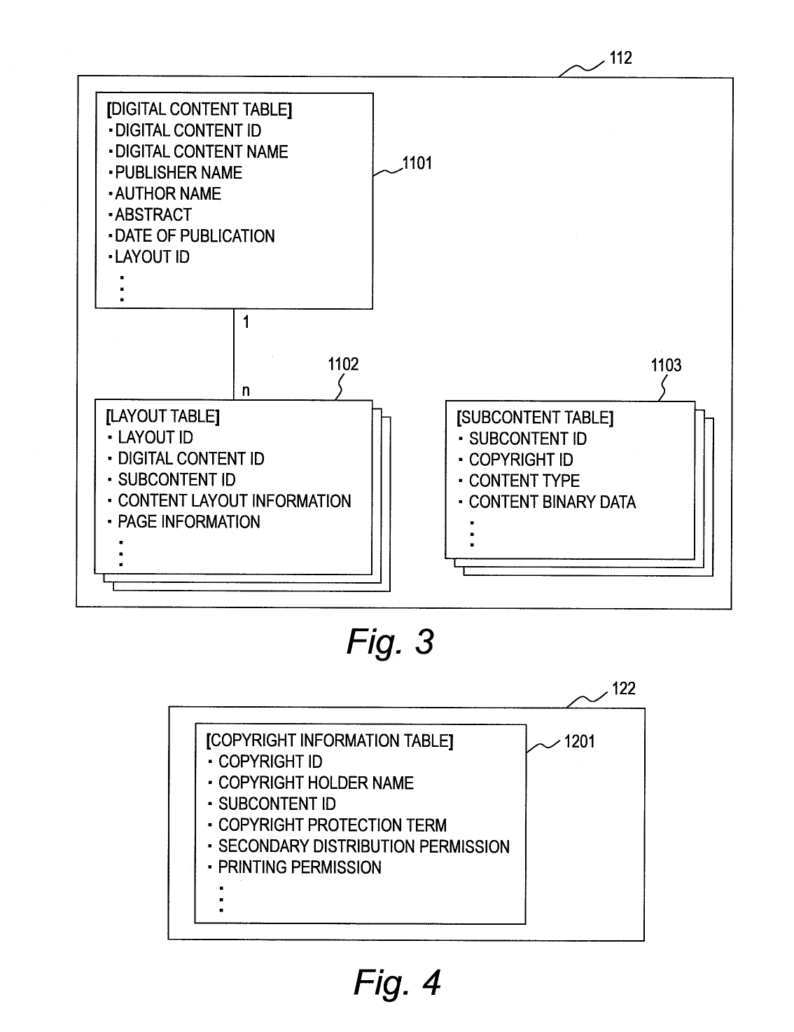

The disk controller 116 controls an access to the storage device 118 according to an instruction received from the processor 113. The storage device 118 is constructed by a magnetic disk, a non-volatile semiconductor memory, or the like, and stores a digital content database 112 (refer to FIG. 3) in a memory area. The network I/F 117 is coupled to the intranet 102, and controls data communication with other devices.

When the digital content management server 110 receives, from the registration terminal 101 via the intranet 102, a request for registering a digital content or a request for acquiring a digital content, the digital content management program 111 registers the digital content to the digital content database 112, or acquires the digital content from the digital content database 112.

Key information (such as a digital content ID) on the registered digital content is transmitted, via the intranet 102, to the digital content providing server 130. Moreover, when the digital content management server 110 receives, from the registration terminal 101 or the digital content providing server 130 via the intranet 102, a request for referring to digital content information, the digital content management program 111 makes an inquiry to the digital content data base 112, and transmits a result of the inquiry to the registration terminal 101 or the digital content providing server 130, which is the source of the request.

Though FIG. 2 illustrates the configuration of the digital content management server 110, other servers such as the copyright management server 120, the digital content providing server 130, and the license authentication server 140 have the same hardware configuration except for installed programs and data stored in the storage device 118.

The digital content management server 110, the copyright management server 120, the digital content providing server 130, and the license authentication server 140 may be computers physically different from each other or virtual computers configured by logically dividing the same physical computer.

A description is now given of differences in configuration and function among the copyright management server 120, the digital content providing server 130, the license authentication server 140, and the digital content management server 110.

The copyright management server 120 has a copyright information database 122 (refer to FIG. 4) stored in the storage device 118, and a copyright management program stored in the main memory 115 for managing the copyright information database 122. Moreover, the copyright management server 120 couples, via the network I/F 117, to the intranet 102.

Moreover, when the copyright management server 120 receives a request for registering or updating copyright information via the intranet 102 from the registration terminal 101, the copyright management program makes an access to the copyright information database 122, and registers or updates the copyright information.

Further, when the copyright management server 120 receives a request for referring to copyright information from the registration terminal 101 or the digital content providing server 130 via the intranet 102, the copyright management program makes an inquiry to the copyright information database 122, and transmits a result of the inquiry to the registration terminal 101 or the digital content providing server 130, which is the source of the request.

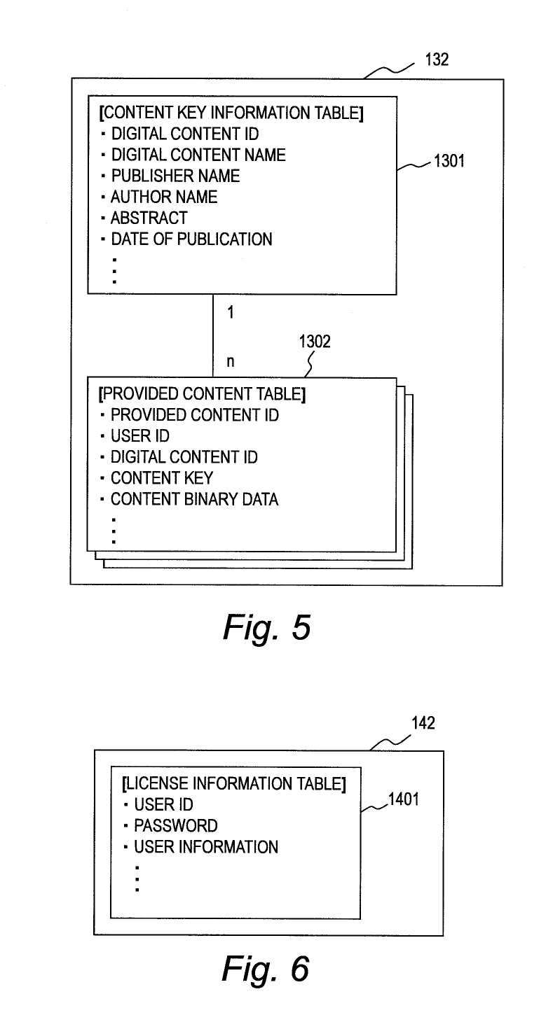

The digital content providing server 130 stores a content information database 132 (refer to FIG. 5) in the storage device 118, and stores a digital content providing program for managing the content information database 132 in the main memory 115. Moreover, the digital content providing server 130 couples, via the network I/F 117, to the intranet 102 and the global network 103.

When the digital content providing server 130 receives, from the user terminal 106 via the global network 103, a request for acquiring a digital content, the digital content providing program makes an inquiry to the content information database 132, and obtains key information (digital content ID) on the corresponding content. The acquired key information on the content is set to a request for digital content acquisition, and is sent to the digital content management server 110.

The license authentication server 140 stores a license information database 142 (refer to FIG. 6) in the storage device 118, and a digital license authentication program in the main memory 115 for managing the license information database 142. Moreover, the license authentication server 140 couples, via the network I/F 117, to the intranet 102 and the global network

When the license authentication server 140 receives, from the end-user terminal 106 via the global network 103, a request for user authentication, the license authentication program 141 makes an inquiry to the license information database 142, and carries out authentication processing for a corresponding user. Then, the license authentication server 140 transmits an acquired content key via the intranet 102 to the end-user terminal 106.

FIG. 3 is a diagram illustrating a configuration of the digital content database 112 according to the embodiment of this invention.

The digital content database 112 is held by the digital content management server 110, and includes a digital content table 1101, layout tables 1102, and subcontent tables 1103. If a new content is generated, a new record is to be registered to those tables.

The digital content table 1101 is a parent table for managing generated contents, and includes digital content IDs, digital content names, publisher names, author names, abstracts, dates of publication, layout IDs, and the like. The digital content table 1101 is associated with the layout tables 1102 by the layout ID. In other words, a plurality of pieces of layout data corresponding to layouts (such as pages) contained in one digital content is associated with one piece of digital content data.

The layout table 1102 is a child table of the digital content table 1101, and is provided for each page, for example. The layout table 1102 is a table for managing information on the layout of subcontents, and includes data such as layout IDs, digital content IDs, subcontent IDs, content layout information, and page information.

The subcontent table 1103 is a table for managing subcontents, and includes subcontent IDs, copyright IDs, data such as content type, and binary data of contents. It should be noted that a subcontent is the minimum unit for managing copyrights of documents, images, music compositions, and the like. Binary data contained in the subcontent table 1103 are not encrypted.

FIG. 4 is a diagram illustrating a configuration of the copyright information database 122 according to the embodiment of this invention.

The copyright information database 122 is held by the copyright management server 120, and contains a copyright information table 1201 for managing all of the copyright information pieces registered to the computer system according to this embodiment.

The copyright information table 1201 contains copyright IDs, copyright holder names, subcontent IDs, copyright protection terms, secondary distribution permission flags, print permission flags, and the like, and, when new copyright information is added, a new record is registered to the copyright information table 1201. In the copyright protection term, the last day of protection by a copyright is recorded. This copyright protection term may be calculated based on a legal protection term, or a copyright holder may set a term shorter than the legal protection term.

FIG. 5 is a diagram illustrating a configuration of the content information database 132 of the embodiment according to this invention.

The content information database 132 is held by the digital content providing server 130, and contains a content key information table 1301 and provided content tables 1302.

The content key information table 1301 manages key information used when the end-user terminal 106 searches for a digital content, and contains digital content IDs, digital content names, publisher names, author names, abstracts, dates of publication, and the like.

The provided content table 1302 is a child table of the content key information table 1301, and is associated with the content key information table 1301 by the digital content ID.

The provided content table 1302 is a table for managing digital contents provided for end users, and contains provided content IDs, user IDs, digital content IDs, content keys, content binary data, and the like. The content binary data is an encrypted digital content provided for an end user, and the content key is information used for decrypting the encrypted digital content.

When a digital content is generated, a new record is registered to the content key information table 1301. Moreover, when a digital content is provided for the end-user terminal 106, a new record is registered to the provided content table 1302. It should be noted that a record registered to the provided content table 1302 may be deleted when a predetermined period has elapsed after a digital content was provided for an end user.

FIG. 6 is a diagram illustrating a configuration of the license information database 142 of the embodiment according to this invention.

The license information database 142 is held by the license authentication server 140, and contains a license information table 1401 for managing user information.

The license information table 1401 contains user IDs, passwords, user information, and the like. When an end user requests for user registration, a new record is added to the license information table 1401.

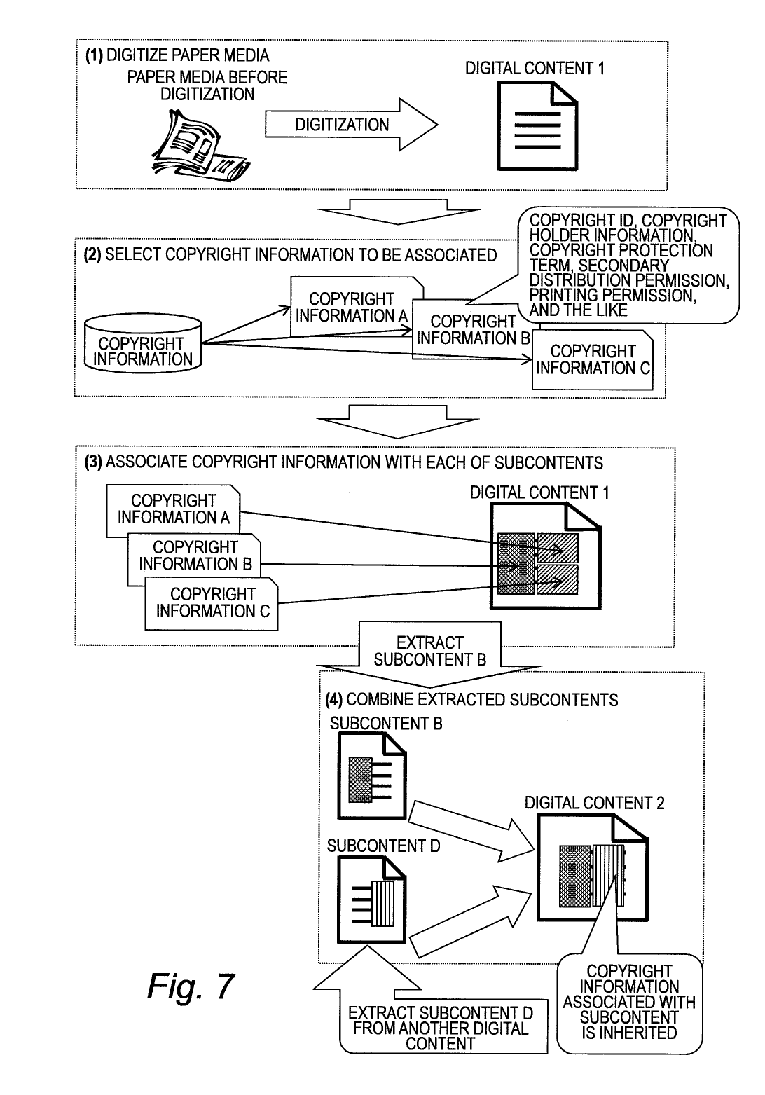

FIG. 7 is a diagram illustrating an overview of processing of creating a file of a digital content according to the embodiment of this invention.

First, in a step (1), the registration terminal 101 converts, by means of an image processing device such as a scanner or an OCR, paper media (information printed on a paper sheet) into digital information, thereby generating a digital content 1. Subcontents contained in the digital content 1 are encrypted, and written to a file, and information on a layout of the subcontents is written to the file without being subjected to encryption.

Then, in a step (2), copyright information to be associated with the generated digital content 1 is selected. The copyright information selected on this occasion is managed by the copyright management server 120, and is stored in the copyright information database 122.

Then, in a step (3), the selected copyright information is associated with each of the subcontents contained in the digital content 1. Then, the copyright information associated with each of the subcontents is written to the subcontent 1 without being subjected to encryption.

In the above-mentioned steps (1) to (3), the digital content 1 is generated, each subcontent of which the copyright information is associated with.

Then, in a step (4), processing of combining a subcontent B extracted from the digital content 1 and a subcontent D extracted from another digital content into a digital content 2 is illustrated.

The subcontent B extracted from the digital content 1 inherits the same subcontent ID. Moreover, in the digital content database 112, a relationship between a subcontent and copyright information, namely a copyright ID corresponding to a subcontent ID is registered. Therefore, even when the subcontent B extracted from the digital content 1 is to be contained in another digital content, the same copyright is inherited.

In the computer system according to this embodiment, copyright information is associated with each of subcontents, and thus even when subcontents extracted from different contents are combined, thereby generating a new digital content, copyright information originally associated with the subcontents is inherited.

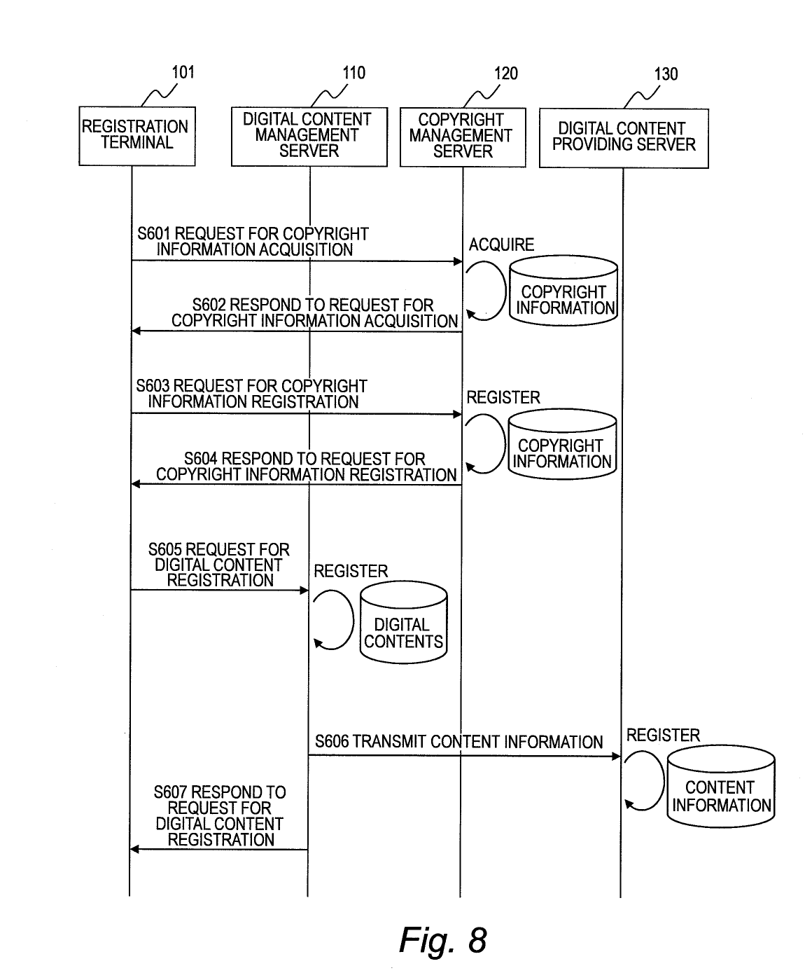

FIG. 8 is sequence diagram of processing of newly registering a digital content by the registration terminal 101 according to the embodiment of this invention.

First, when a digital content registration program starts, the registration terminal 101 makes a request for copyright information acquisition to the copyright management server 120 (S601). When the acquisition of the copyright information is requested, the copyright management server 120 transmits all of the copyright information pieces stored in the copyright information database 122 to the registration terminal 101 (S602).

Then, the registration terminal 101 digitizes a book or the like, thereby generating a digital content. A file of the generated digital content contains at least one subcontent, information on layouts for arranging the subcontents, and attribute information on the digital content (such as content keys). Then, one piece of the acquired copyright information is associated with each of subcontents contained in the digital content, and an ID of the associated copyright information is written to the file of the digital content. Then, the registration terminal 101 requests the copyright management server 120 to register the copyright information associated with the digital content (S603). It should be noted that the registration terminal 101 may not select the copyright information acquired from the copyright information database 122, but may input new copyright information, and may request for registration of the new copyright information.

When the copyright management server 120 receives the request for registration of the copyright information from the registration terminal 101, the copyright management server 120 registers the received copyright information to the copyright information database 122, and returns a result of the registration to the registration terminal 101 (S604). Then, the registration terminal 101 requests the digital content management server 110 to register the digital content associated with the copyright information (S605).

When the digital content management server 110 receives the request for registration of the digital content, the digital content management server 110 registers the received digital content to the digital content database 112. Specifically, digital content data to be stored in the digital content table 1101, layout data to be stored in the layout table 1102, and subcontent data to be stored in the subcontent table 1103 are registered to the digital content database 112.

Then, the digital content management server 110 transmits key information on the received digital content (such as the digital content ID and the digital content name) to the digital content providing server 130 (S606). The digital content providing server 130 registers the received key information on the digital content to the content information database 132 (content key information table 1301).

After the digital content management server 110 transmits the key information to the digital content providing server 130, the digital content management server 110 returns, to the registration terminal 101, a reply indicating the completion of the processing (S607). It should be noted that the digital content management server 110 may receive, from the digital content providing server 130, a reply indicating completion of the registration of the key information on the digital content, and then may reply, to the registration terminal 101, the completion of the processing.

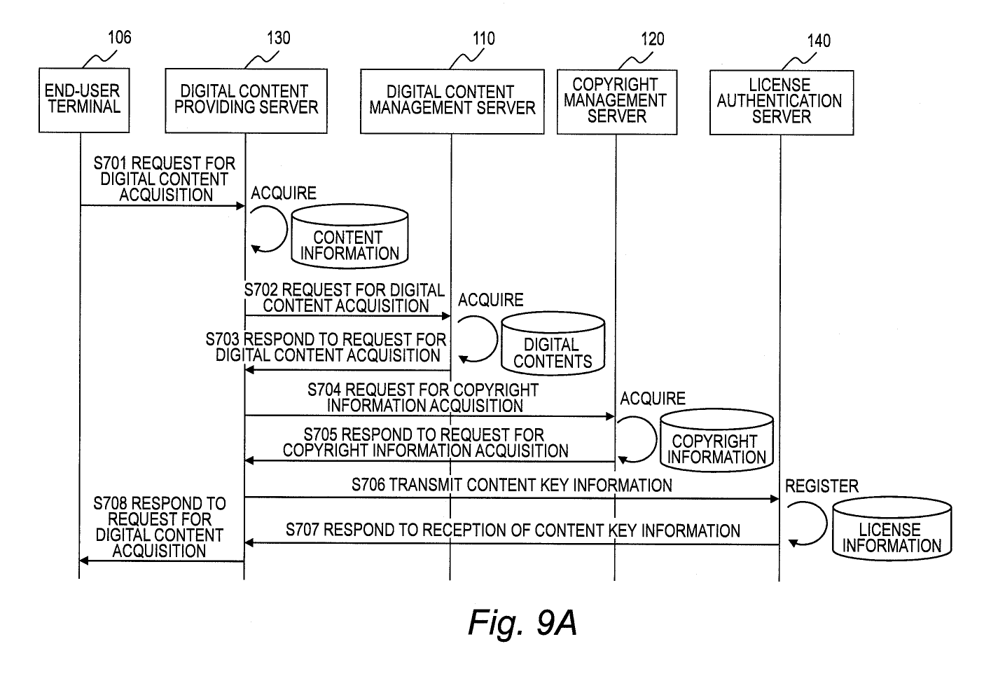

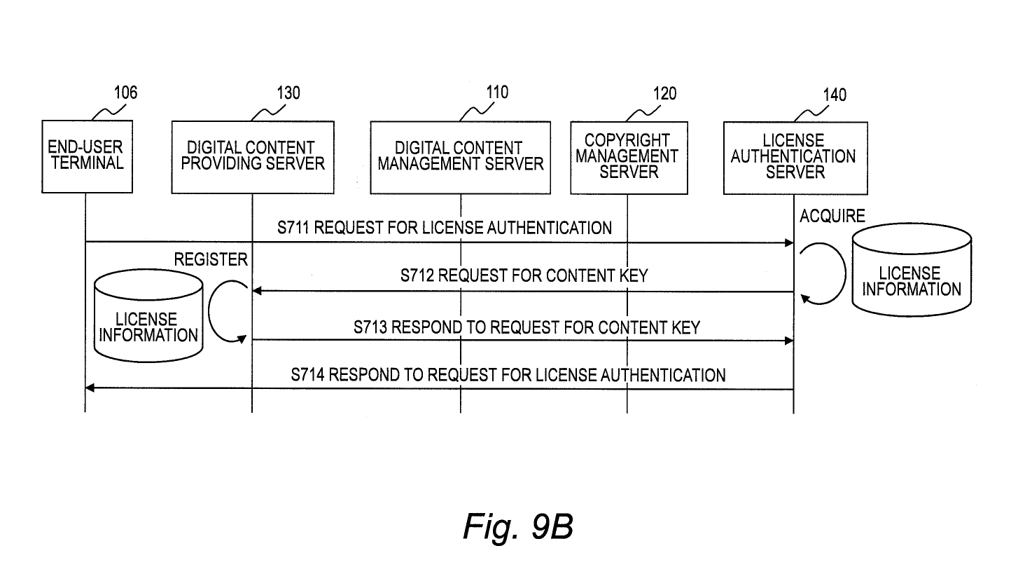

FIG. 9A is a sequence diagram of processing of acquiring a digital content by the end-user terminal 106 according to the embodiment of this invention.

When the digital content is acquired, first, the end-user terminal 106 makes a request for the digital content acquisition to the digital content providing server 130 (S701). The request for digital content acquisition contains information for identifying or narrowing down the digital content to be acquired. The information used for identifying or narrowing down the digital content is information input by a user to the end-user terminal 106, and may be information contained in the content key information table 1301 of the content information database 132.

Moreover, this request for digital content acquisition contains a user ID and a password input when the digital content acquisition is requested from the end-user terminal 106. As the user ID and the password, a user ID and a password held in the end-user terminal 106 may be used.

When the digital content providing server 130 receives the request for digital content acquisition, based on the information used for identifying or narrowing down the digital content contained in the request for digital content acquisition, the digital content providing server 130 searches the content key information table 1301, thereby acquiring key content information (such as a digital content ID). Then, the digital content providing server 130 transmits a request for digital content acquisition containing the acquired content key information to the digital content management server 110 (S702).

When the digital content management server 110 receives the request for digital content acquisition, the digital content management server 110 searches the digital content database 112 by using the content key information contained in the received request for digital content acquisition. Specifically, the digital content management server 110 searches the digital content table 1101 by using the received digital content ID, thereby acquiring the ID of a layout of the content. Then, the digital content management server 110 searches the layout table 1102 by using the acquired layout ID, thereby acquiring IDs of subcontents contained in the layout. Then, the digital content management server 110 searches the subcontent table 1103 by using the acquired subcontents IDs, thereby acquiring subcontent data. Then, the digital content management server 110 returns the acquired layout data and subcontent data to the digital content providing server 130 (S703). Each of the returned subcontents contains an ID of a copyright set to each of the pieces of the subcontent data.

Then, the digital content providing server 130 transmits a request for copyright information acquisition containing the acquired copyright IDs to the copyright management server 120 (S704). When the copyright management server 120 receives the request for copyright information acquisition, the copyright management server 120 searches the copyright information database 122 by using the copyright IDs contained in the received request for copyright information acquisition, and returns corresponding copyright information to the digital content providing server 130 (S705).

The digital content providing server 130 combines, according to the layout data acquired in S703, the pieces of the subcontent data acquired in S703, thereby generating the digital content to be provided for the end-user terminal 106. The generated digital content is data of image for browsing which can be displayed on a dedicated viewer of the end-user terminal 106. Then, the digital content providing server 130 encrypts the generated content. Moreover, the digital content providing server 130 registers the data of the generated digital content to the provided content table 1302. Then, the digital content providing server 130 transmits a decryption key (content key) generated at the time of the encryption to the license authentication server 140 (S706).

When the license authentication server 140 receives the content key, the license authentication server 140 registers the received content key to the license information database 142, and then returns a reply indicating that the content key has been registered to the digital content providing server 130 (S707).

When the digital content providing server 130 receives the reply from the license authentication server 140, the digital content providing server 130 transmits the encrypted content to the end-user terminal 106 (S708).

The end-user terminal 106 stores the acquired digital content in the storage device.

FIG. 9B is a sequence diagram of processing of browsing a digital content by the end-user terminal 106 according to the embodiment of this invention.

When the digital content is browsed, first, the end-user terminal 106 reads key information (provided content ID) from the digital content to be browsed. Though the content to be browsed provided by the digital content providing server 130 is encrypted, the key information is contained in the digital content so that the key information may be read without being subjected to decryption.

Then, the end-user terminal 106 transmits a user ID, a password, and the read provided content ID to the license authentication server 140, thereby requesting for license authentication (S711). As the user ID and the password, a user ID and a password input by the user to the end-user terminal 106, or a user ID and a password held by the end-user terminal 106 are used.

When the license authentication server 140 receives the request for license authentication, the license authentication server 140 searches the license information database 142 by using the user ID and the password contained in the received request for license authentication. As a result, if the received user ID and password are recorded in the license information database 142, the user using the end-user terminal 106 is a valid user, and the license authentication server 140 transmits the provided content ID and the user ID contained in the received request for license authentication to the digital content providing server 130, thereby requesting for a content key (S712).

When the digital content providing server 130 receives the provided content ID and the user ID, the digital content providing server 130 searches the content information database 132, identifies a content key corresponding to the provided content ID and the user ID, and returns the identified content key to the license authentication server 140 (S713).

When the license authentication server 140 receives the content key from the digital content providing server 130, the license authentication server 140 transmits, to the end-user terminal 106 which has requested the license authentication, a response to the request for license authentication (S714). The response to the request for license authentication contains the provided content ID of the digital content, the authentication of which the end-user terminal 106 has requested, and the content key acquired from the content providing server 130.

It should be noted that as a result of the search on the license information database 142 by using the user ID and the password contained in the received request for license authentication, if the received user ID and password are not recorded in the license information database 142, the user using the end-user terminal 106 is not a valid user, and, without requesting for a content key from the digital content providing server 130, the license authentication server 140 transmits a reply indicating that the authentication has failed to the end-user terminal 106 (S714).

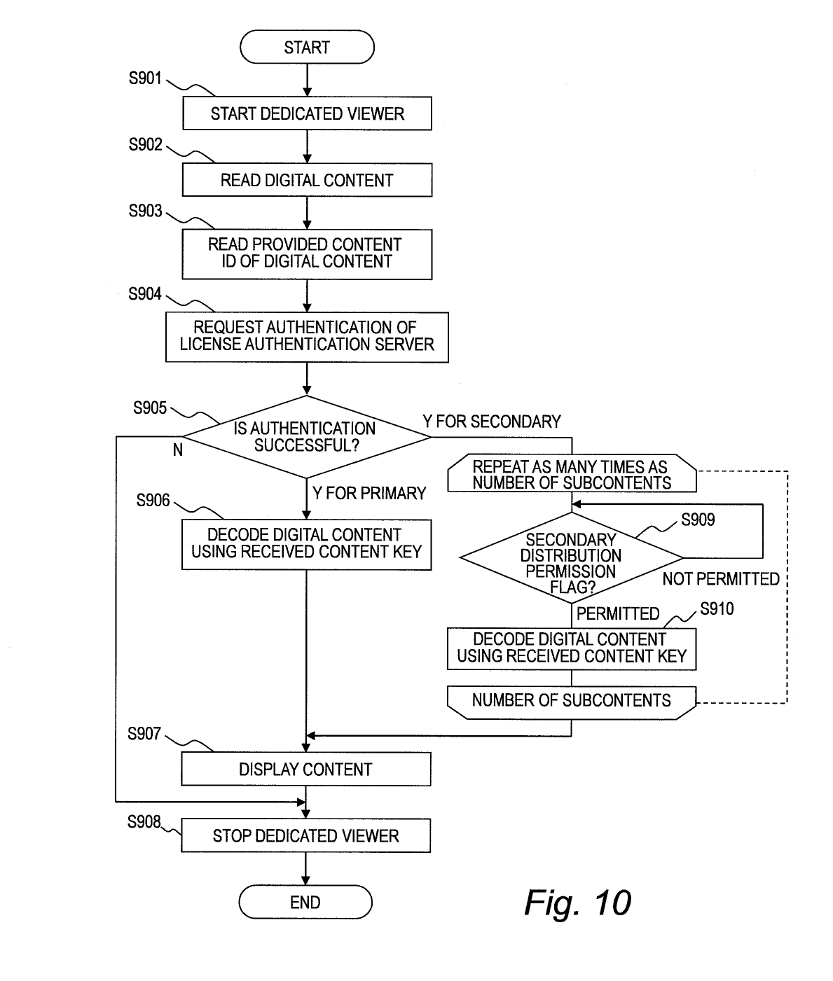

FIG. 10 is a flowchart of processing of browsing a digital content according to the embodiment of this invention.

The processing of browsing a digital content illustrated in FIG. 10 is carried out by the end-user terminal 106. When a digital content generated by the system according to this embodiment is browsed on the end-user terminal 106, a dedicated viewer is used. User information (such as a user name and an area) is set to this dedicated viewer in advance.

First, the processor of the end user terminal 106 starts the dedicated viewer (S901). When the dedicated viewer starts, the dedicated viewer requests the user to input a user ID and a password. It should be noted that the user ID and the password may be set to the dedicated viewer in advance.

Then, the processor reads the digital content acquired by the digital content acquisition processing (FIG. 9A) from the storage device 118 (S902). The dedicated viewer may show a list of digital contents stored in the storage device 118, and the user may select the digital content to be read from the list. Moreover, the dedicated viewer may request the user to input information on the digital content to be read.

Then, the processor reads the provided content ID from the read digital content (S903). It should be noted that the provided content ID is written in the digital content in the non-encrypted form as the attribute information on the digital content.

Then, the processor requests the license authentication server 140 to carry out the license authentication (S904, S711 in FIG. 9B). When the processor receives an authentication result from the license authentication server 140 (S714 in FIG. 9B), the processor determines the authentication result transmitted from the license authentication server 140 (S905).

When the authentication by the license authentication server 140 fails, the processing proceeds to Step S908, shows the fact that the authentication has failed, and stops the started dedicated viewer. In this case, the digital content is not displayed.

On the other hand, when the authentication by the license authentication server 140 is successful, the processor refers to a user ID in the provided content table 1302 of the content information database 132, which is set to the digital content, and determines whether or not the digital content, the authentication of which is successful, is a primary distribution or a secondary distribution. Specifically, the processor compares the user ID in the provided content table 1302 of the content information database 132 and the user ID input when the dedicated viewer is started with each other, and if those two user IDs are the same, the user is a person who has generated the digital content identified by the provided content ID, and thus the processor can determine that the digital content is a primary distribution. Moreover, if those two user IDs are different from each other, the user is not the person who has generated this digital content, and thus the processor can determine that the digital content is a secondary distribution.

As a result, if the processor determines that the digital content is a primary distribution, the processor decrypts, by using the content key transmitted from the license authentication server 140, an encrypted portion of the digital content (S906).

Then, the processor displays the decrypted digital content on a display unit of the end-user terminal 106 (S907). Then, by an operation of the user, the dedicated viewer is stopped (S908).

On the other hand, if the processor determines that the digital content is a secondary distribution, the processor refers to the secondary distribution permission flag of copyright information of a subcontent contained in the digital content to be displayed, and determines whether or not secondary distribution of the subcontent is permitted (S909). As a result, if the secondary distribution is not permitted, the subcontent cannot be displayed as the secondary distribution, and the processor determines whether or not the secondary distribution of a next subcontent is permitted. It should be noted that if the secondary distribution is not permitted, an area for the subcontent may be masked after the subcontent is decrypted.

On the other hand, the secondary distribution is permitted, the subcontent can be displayed as the second distribution, and the processor decrypts the encrypted portion of the digital content by using the content key transmitted from the license authentication server 140 (S910).

It should be noted that the processing from Step S909 to Step S910 is repeated as many times as the number of the subcontents contained in the digital content to be displayed.

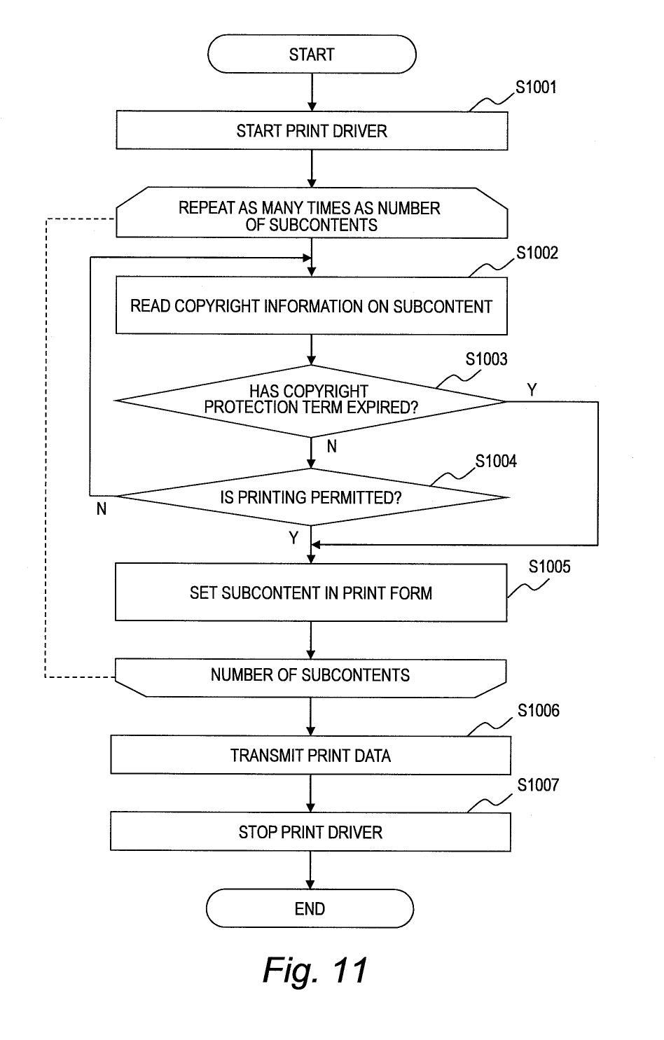

FIG. 11 is a flowchart of processing of printing a digital content according to the embodiment of this invention.

First, the dedicated viewer running on the end user terminal 106 starts a print driver (S1001). It should be noted that when the print drive starts, a digital content to be printed has been decrypted.

Then, the processor of the end user terminal 106 reads copyright information on a subcontent contained in the digital content to be printed from the digital content (S1002). Then, the processor determines, by referring to a copyright protection term of the read copyright information, whether or not protection of the subcontent by the copyright has expired (S1003). As a result, if the protection term of the copyright has expired, the protection of the subcontent by the copyright is not necessary, and the processing proceeds to Step S1005.

On the other hand, if the protection term of the copyright has not expired, the subcontent is protected by the copyright. Therefore, the processor refers to the print permission flag of the copyright information, thereby determining whether or not the subcontent can be printed (S1004). As a result, if this subcontent can be printed, the processor sets the subcontent to a print form (S1005). On the other hand, if the subcontent cannot be printed, the processing returns to Step S1002, and processes a next subcontent. When the printing is not permitted, an area for the subcontent may be masked after the subcontent is decrypted.

It should be noted that the processing from Step S1002 to Step S1005 is repeated as many times as the number of the subcontents contained in the digital content to be printed.

In other words, if the copyright protection term of the subcontent has not expired, and the printing of the subcontent is not permitted, the subcontent is not set to the print form, and a portion for this subcontent is blanked. Moreover, if the copyright protection term of the subcontent has expired, or the print of the subcontent is permitted, the subcontent is set to the print form, and is printed.

When the determination of the copyright has made for all the subcontents (S1002 to S1005), in order to print the form to which the subcontents are set, print data is transmitted to a printer (S1006). Then, the print driver stops (S1007).

As mentioned before, according to the embodiment of this invention, when a digital content (electronic book) is generated from a book, copyright information is associated with each of subcontents (documents and images contained in the book), and a file containing the copyright information is generated. The copyright information is independently associated with the subcontents, and according to each copyright policy, the print, the secondary distribution, and the like can be controlled.

Moreover, when subcontents are extracted from a file, and, by combining the extracted subcontents, a new digital content is generated, a copyright set to each of the subcontents can be inherited.

Further, when a file to which copyright information is added is to be browsed, the permission of the display is determined for each of the subcontents. Further, when the file to which copyright information is added is to be printed, the permission of the print is determined for each of the subcontents.

Therefor, for each of the subcontents contained in the digital content, the copyright can be properly protected. Moreover, when the digital content is edited, the copyright set to each of the subcontents can be inherited, the digital content comes to be used more, and a wide variety of services using the digital content can be provided.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a content providing server for providing a user terminal with a digital content obtained through digitization; and
a copyright management server for managing copyright information on the digital content,
wherein the content providing server is configured to:
obtain copyright information set for each of subcontents included in the digital content from the copyright management server;
associate the obtained copyright information with the each of the subcontents, and add the copyright information to the digital content; and
transmit the digital content to which the copyright information is added to the user terminal.

2. The computer system according to claim 1, further comprising an authentication server for authenticating the user terminal, wherein:
the content providing server is configured to:
encrypt the digital content to which the copyright information is added before the transmission to the user terminal; and
manage a decryption key for decrypting the encrypted digital content; and
the authentication server is configured to:
determine whether or not an authentication request is received from a valid user, in a case where the authentication request is received from the user terminal; and
request the content providing server to provide the decryption key for decrypting the encrypted content, and transmit the decryption key transmitted from the content providing server along with an authentication result to the user terminal, in a case where the authentication request is received from the valid user.

3. The computer system according to claim 1, further comprising a content management server for managing data of a digitized content, wherein:
the content management server is configured to, set the same identifier to a first subcontent and a second subcontent, in a case where the second subcontent which is the same as the first subcontent extracted from a first digital content is embedded in a second digital content; and
the content providing server is configured to use the identifier of the subcontents to obtain the copyright information set to the each of the subcontents from the copyright management server, thereby associating the first subcontent and the second subcontent with the same copyright information.

4. The computer system according to claim 1, further comprising a user terminal, wherein:
the content providing server sets an identifier of the user terminal to which the digital content is transmitted for a first time to the digital content; and
the user terminal is configured to:
determine whether or not the identifier of the user terminal set to the digital content is the same as an own identifier;
read the copyright information associated with the each of the subcontents included in the digital content, in a case where both the identifiers are different from each other;
determine whether or not a secondary distribution is permitted for the each of the subcontents based on the read copyright information;
display the digital content including the subcontent, in a case where the secondary distribution of the subcontent is permitted; and
display the digital content excluding the subcontent, in a case where the secondary distribution of the subcontent is not permitted.

5. The computer system according to claim 1, further comprising a user terminal, wherein the user terminal is configured to:
read the copyright information associated with the each of the subcontents included in the digital content received from the content providing server;
determine whether or not printing is permitted for the each of the subcontents based on the read copyright information;
print the digital content including the subcontent, in a case where the printing of the subcontent is permitted; and
print the digital content excluding the subcontent, in a case where the printing of the subcontent is not permitted.

6. A computer system, comprising:
a content management server for managing data of a digital content obtained through digitization; and
a copyright management server for managing copyright information on the digital content,
wherein the content management server is configured to manage layout data indicating subcontents included in the digital content to be managed and subcontent data indicating a copyright set to each of the subcontents, to thereby manage, for the each of the subcontents, the copyright information to be managed by the copyright management server.

7. A content management method used in a computer system including a content providing server for providing a user terminal with a digital content obtained through digitization, and a copyright management server for managing copyright information on the digital content, the content management method including:
obtaining, by the content providing server, copyright information set for each of subcontents included in the digital content from the copyright management server;
associating, by the content providing server, the obtained copyright information with the each of the subcontents, and adding the copyright information to the digital content; and
transmitting, by the content providing server, the digital content to which the copyright information is added to the user terminal.

8. The content management method according to claim 7, wherein:
the computer system further includes an authentication server for authenticating the user terminal; and
the content management method further includes:
encrypting, by the content providing server, the digital content to which the copyright information is added before the transmission to the user terminal;
managing, by the content providing server, a decryption key for decrypting the encrypted digital content;
determining, by the authentication server, whether or not an authentication request is received from a valid user, in a case where the authentication request is received from the user terminal; and
requesting, by the authentication server, the content providing server to provide the decryption key for decrypting the encrypted content, and transmitting the decryption key transmitted from the content providing server along with an authentication result to the user terminal, in a case where the authentication request is received from the valid user.

9. The content management method according to claim 7, wherein:
the computer system further includes a content management server for managing data of the digital content; and
and the content management method further includes:
setting, by the content management server, the same identifier to a first subcontent and a second subcontent, in a case where the second subcontent which is the same as the first subcontent extracted from a first digital content is embedded in a second digital content; and
using, by the content providing server, the identifier of the subcontents to obtain the copyright information set to the each of the subcontents from the copyright management server, thereby associating the first subcontent and the second subcontent with the same copyright information.

10. The content management method according to claim 7, wherein:
the computer system further includes a user terminal; and
the content management method further includes:
setting, by the content providing server, an identifier of the user terminal to which the digital content is transmitted for a first time to the digital content;
determining, by the user terminal, whether or not the identifier of the user terminal set to the digital content is the same as an own identifier;
reading, by the user terminal, the copyright information associated with the each of the subcontents included in the digital content, in a case where both the identifiers are different from each other;
determining, by the user terminal, whether or not a secondary distribution is permitted for the each of the subcontents based on the read copyright information;
displaying, by the user terminal, the digital content including the subcontent, in a case where the secondary distribution of the subcontent is permitted; and
displaying, by the user terminal, the digital content excluding the subcontent, in a case where the secondary distribution of the subcontent is not permitted.

11. The content management method according to claim 7, wherein:
the computer system further includes a user terminal; and
the content management method further includes:
reading, by the user terminal, the copyright information associated with the each of the subcontents included in the digital content received from the content providing server;
determining, by the user terminal, whether or not printing is permitted for the each of the subcontents based on the read copyright information;
printing, by the user terminal, in a case where the printing of the subcontent is permitted, the digital content including the subcontent; and
printing, by the user terminal, the digital content excluding the subcontent, in a case where the printing of the subcontent is not permitted.

12. The content management method according to claim 7, wherein:
the computer system further includes a content management server for managing data of the digital content; and
the content management server manages layout data indicating the subcontents included in the digital content to be managed and subcontent data indicating a copyright set to the each of the subcontents, to thereby manage, for the each of the subcontents, the copyright information to be managed by the copyright management server.
